(19) United States
(12) Patent Application Publication
(10) Pub. No.: US 2006/0225091 A1
(43) Pub. Date: Oct. 5, 2006

(54) Customizing and personalizing views in content aggregation frameworks

(76) Inventors: Michael D. Facemire, Cary, NC (US); Patrick G. McGowan, Stoney Creek, NC (US); Michael C. Wanderski, Durham, NC (US)

Correspondence Address: MARCIA L. DOUBET LAW FIRM, PO BOX 422859, KISSIMMEE, FL, 34742, US

(21) Appl. No.: 11/099,311

(22) Filed: Apr. 5, 2005

(51) Int. Cl. H04N 7/10; G06F 13/00; H04N 7/025; G06F 3/00; H04N 5/445

(52) U.S. Cl. 725/35; 725/37; 725/34

(57) ABSTRACT

Techniques for customizing and personalizing content views that are provided using content aggregation frameworks (such as portal applications). Content transformations may be provided, such that a component is automatically transformed if copied or moved to a content receiver having a particular type. A visual representation of a content component may change as the component is moved about, responsive to moving within proximity of available receiver locations for the component. Visual indicators may be provided to assist the user in determining where each content component can be copied or moved, and/or how the content component will be represented as a result.

### RELATED APPLICATION

The present application is related to commonly-assigned and co-pending U.S. patent application Ser. No. ______, filed Mar. 18, 2005, which is titled “Configuring a Page for Drag and Drop Arrangement of Content Artifacts in a Page Development Tool”. This application is referred to herein as “the related application”. The present application is also related to commonly-assigned and co-pending U.S. patent application Ser. No. ______, which was filed concurrently herewith and which is titled “Enabling Customization and Personalization of Views in Content Aggregation Frameworks”.

### BACKGROUND OF THE INVENTION

1. Field of the Invention

The present invention relates to computer programming, and deals more particularly with providing visual cues to assist users in customizing and personalizing content views that are provided using content aggregation frameworks (such as portal applications).

2. Description of the Related Art

Over the past several years, Web pages have evolved from simple information sites with static content to more dynamic, interactive web-based applications. These richer web-based interfaces commonly use a combination of embedded browser technologies, including confined (i.e., browser-executable) componentry such as Applets or Flash, as well as script-driven technology integrated directly with markup, such as VBScript and Javascript®. (“Javascript” is a registered trademark of Sun Microsystems, Inc.) Recently, browsers have enriched their scripting support to provide a closer level of desktop-like interaction, including the ability to drag content through the movement and transparency of web artifacts within a page. The availability of these scripting features gives web-based applications the opportunity to provide a new level of seamless interaction with end users while maintaining the intrinsic relationship between the web page and its page content, a result that is not easily achieved with the other technologies.

As information and applications have proliferated, web portals have emerged to help an enterprise consolidate its information and applications and provide a consistent user interface across a myriad of web-based applications. A common problem with portals, though, is the proliferation of content and the complexity of configuration that is associated with these applications. Administrators of portal environments are thus faced with a difficult task.

An emerging concept is “workplaces”, an evolution of portal concepts that provides domain-level collaboration and personalization, while enabling all users to become “managers” of applications and content through roles. Workplaces also provide a new platform for application assembly and collaboration, allowing small teams of workers (such as co-workers in a department) to deploy ad hoc “team spaces” in an on-demand manner (such as creating a weekly on-line team room for discussion of marketing or other topics). This new class of web-application developer is not necessarily skilled in application development or customization. Accordingly, as workplaces are deployed in portal environments, the existing difficulties in managing and configuring portal content are compounded greatly, which may negatively impact overall productivity of traditional administrators as well as the users who create, configure, manage, and/or interact with workplace content.

### SUMMARY OF THE INVENTION

The present invention provides techniques for identifying available content receiver locations on a content view generated by a content aggregation framework, comprising: determining, for a content component being moved about a rendered view generated by the content aggregation framework, a source type associated with the content component; identifying one or more available content receiver locations on the rendered view, wherein a particular content receiver location is an available content receiver location if the particular content receiver location is capable of consuming the source type; and visually highlighting at least one of the identified available content receiver locations, responsive to the identification.

The present invention also provides techniques for assisting users in modifying a content view generated by a content aggregation framework, comprising: identifying a content component to be moved or copied from a source location to a receiver location on a rendered view generated by the content aggregation framework; first determining whether a type associated with the content component matches a type of the receiver location, and if so, visually indicating that the content component can be moved or copied to the receiver location; and otherwise next determining whether a transform is available for the content component that transforms the type associated with the content component to a substitute type consumable by the receiver location, and if so, visually highlighting that the content component can be moved or copied to the receiver location.

A content component being moved about may be selected, for example, from a content palette or from already-rendered content components on the view. The visual highlighting may comprise altering a color of at least one identified available content receiver locations, providing a visual connector thereto, and so forth.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will now be described with reference to the following drawings, in which like reference numbers denote the same element throughout.

### BRIEF DESCRIPTION OF THE DRAWINGS

FIGS. 1A and 1B illustrate a sample content component palette of the type that may be used in embodiments of the present invention;

FIG. 2 illustrates dragging a content component from a content palette;

FIG. 3 illustrates provisioning a content field by dragging and dropping an already-rendered content component from one portlet to another;

FIGS. 4 and 5 illustrate visual transformations that may occur when dragging and dropping a content component of a first type onto a content receiver location having a different type;

FIG. 6 provides sample syntax for specifying visual transformations between types;

FIG. 7 illustrates a sample component card that may be associated with a content component according to an aspect of the present invention; and

FIG. 8 shows one way in which visual highlighting may be used to identify available content receiver locations for a content component.

### DESCRIPTION OF PREFERRED EMBODIMENTS

The present invention provides techniques whereby users may configure and personalize page content such as that rendered in a portal or workplace. In preferred embodiments, a drag-and-drop paradigm is used for dynamic, inline assembly of content components. Type-based transformations may be performed automatically, responsive to a user's copying or moving of a content component of a first type to a receiver location having a different type. Visual proximity-based transformations of the content component's representation may be provided, as the content component is moved within proximity of available receiver locations. Visual indicators may be provided to assist the user in identifying the available receiver locations and/or a result of copying or moving the component to a particular receiver location. Users can perform page-specific customization and personalization, and the automated transformations enable page content to dynamically adapt to user modifications.

As used herein, the term “content component” (or, equivalently, “content object” or “content artifact”) refers to any markup artifact on a page (e.g., an entire rendered portlet, an image, a form, a list of items, a table, etc.) augmented with additional configuration data (which may be expressed in markup language, scripting language, or the like). Thus, content components have both a visual component and an expression of configuration data. Content components may thus serve as a base component for applying dynamic configuration and personalization to a page.

According to preferred embodiments, all content components are expressed with one or more types, which may be simple types like “image” or “text”. Embodiments of the present invention may optionally support complex types. For example, a List portlet could express a List field as a new type by bounding the content component to particular configuration data values and to a section of page markup representing the field. Complex content components can be stored as a newly-defined content component in a content component registry. Definition of components can be done in various ways, including provision of a library of predefined components (which may then be used by reference) or by providing a visual tool whereby users can select rendered content to be used as the basis for a content component and, as needed, can provide parameters therefor.

Content components can be dragged from one (i.e., source) location and dropped onto another (i.e., receiver) location, where the receiver location is also referred to herein as a “drop zone”. Preferably, a result of this drag-and-drop operation is a copy of the content component at the drop zone, although provision may be made for moving the content component to the drop zone if desired. In preferred embodiments, content drop zones have associated therewith one or more types that the zone is capable of consuming, as well as an action to be taken when content of a particular type is dropped on that drop zone. (Refer to the related application for more information about defining drop zones and defining draggable content components.)

In preferred embodiments, content components and drop zones are matched based on a common type. Examples addressing drop zone types are discussed below with reference to the figures. If the allowable types for a particular drop zone do not match the type of a content component, considering the available transformations for the content component, then that content component cannot be dropped in that drop zone.

The act of dragging and dropping a content component onto a drop zone is used to apply a level of customization to the consuming portlet or receiver location through the configuration expression provided by the content component. So, for example, each individual user may modify page content according to the desires of that particular user. (The terms “customization” and “personalization” are used herein in a generic sense to refer to user modifications or configuration of content views; the reason behind the user's modifications is not relevant to the scope of the present invention. Similarly, the terms “modification” or “configuration” are used interchangeably herein.)

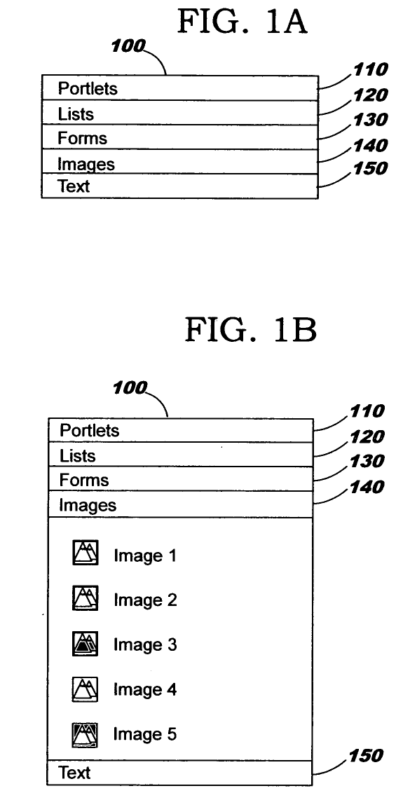

In one approach, content components may be made available from a palette of components. The palette may be provided, for example, as a slideout palette in a portal page. FIG. 1A illustrates a sample palette 100 from which a number of different types (110, 120, 130, 140, 150) of content components may be selected. In FIG. 1B, this same sample palette 100 is shown with its “Image” choice 140 having been expanded to provide access to the currently-available content components of that particular type. (A content component palette may be populated in a number of ways, details of which do not form part of the present invention.)

In another approach, content components may be made available from inline (i.e., already-rendered) page content. For example, an image rendered in a banner ad portlet may be used as a content component that can be dragged from its rendered location to drop zones that accept content components of type “image”. Notably, these target drop zones may be located in the same portlet as the inline portlet content, and/or in different portlets. (Refer to the related application for more information on making a content component draggable; in preferred embodiments, this comprises providing scripting language commands for a representation of the content component.)

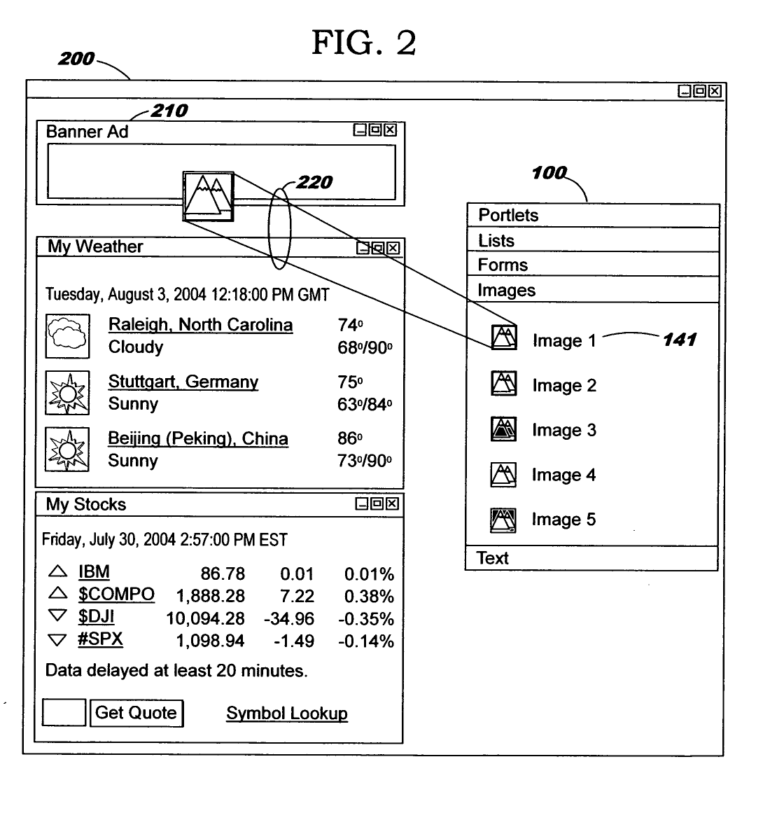

An example of customizing a portal or workplace using content components is to drag an image from a content palette onto an image portlet to specify what image is shown by that portlet. This is illustrated in FIG. 2, where an image identified as “Image 1” 141 is dragged (as shown generally by 220) from content palette 100 to a previously-empty banner ad portlet 210 in a portal page 200, thus configuring this user's view of portlet 210.

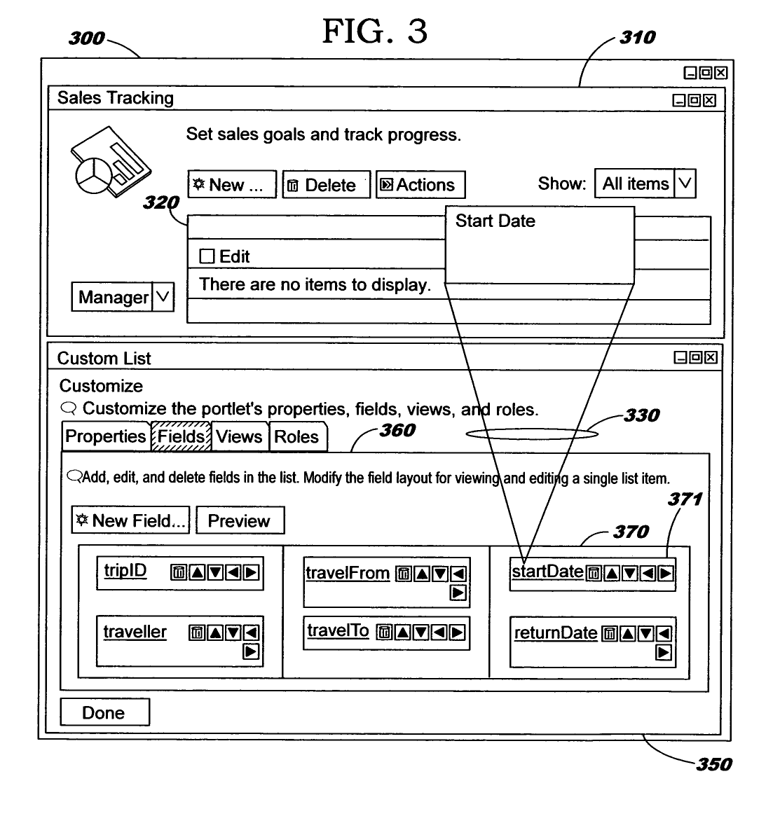

Another example of applying configuration changes using content components is to drag a form input field from one List portlet onto another List portlet to provision a similar field in the consuming portlet. (A “consuming portlet”, as that term is used herein, refers to a portlet having a drop zone onto which a content component is dropped.) This example is illustrated in FIG. 3. In FIG. 3, a portal page 300 comprises a Sales Tracking portlet 310 and a Custom List portlet 350. (Notably, the content of portlets 310 and 350 may be completely unrelated.) Custom List portlet 350 includes a Fields view 360, and in this example, six different fields are provided in the list at 370. A field “startDate” 371 is dragged (as shown generally by 330) to a previously-empty area 320 of portlet 310, thus signifying that a “Start Date” field is desired in the Sales Tracking portlet 310.

Visual transforms may be registered for each content and drop zone type match. (Refer to the related application for more information about the manner in which such a registry may be provided.) For example, a visual transform may specify that if an image content component is dragged and dropped onto an image-type drop zone (e.g., for configuring what image to show, as discussed above with reference to FIG. 2), the dropped image content component is to be represented as a resized version of the image. Thus, in FIG. 2, the image identified in palette 100 as “Image 1” 141 may be resized to better fit in its consuming portlet 210. The visual transform may specify, for example, that the newly-dropped image is to be rendered as a particular size or using a relative size (which may be increased or decreased, as compared to the source image). Information from the registered transforms may be displayed to the user to assist the user in determining whether a content component matches a drop zone, and/or how the content component will be represented if dropped in that drop zone.

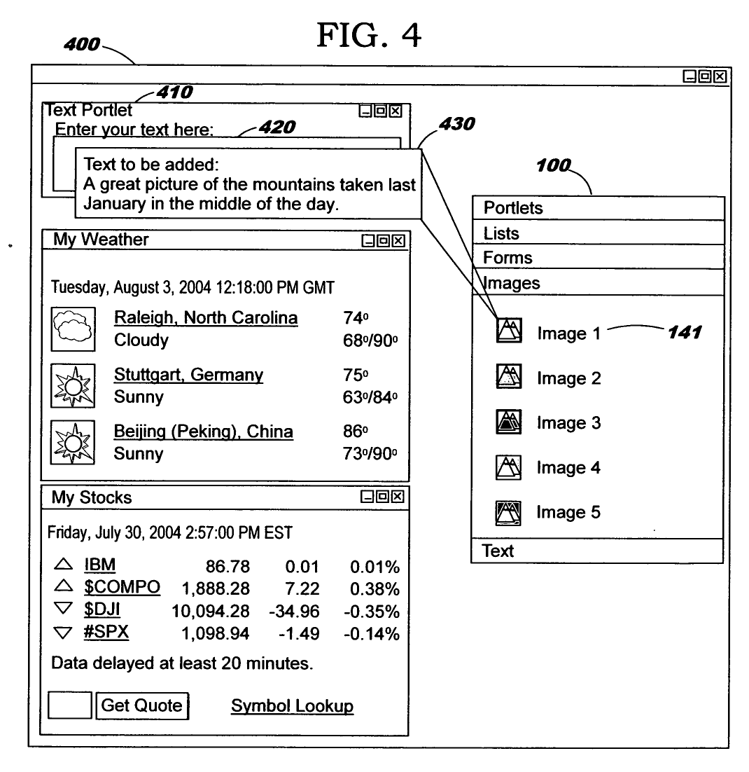

By contrast, a visual transform may specify that if an image content component is dragged and dropped onto a text-type drop zone, then the image content component is to be visually transformed into text representing that image (e.g., using the image's corresponding description as textual input for the text-type drop zone). This is illustrated in FIG. 4, where “Image 1” 141 is now dragged from palette 100 onto a portlet named “Text Portlet” 410 in portal page 400. Supposing, for this example, that Text Portlet 410 has a drop zone 420 that accepts text-type content components, and that the description corresponding to “Image 1” is “A great picture of the mountains taken last January in the middle of the day.”, a preview-type view 430 of this text is provided when “Image 1” 141 is dragged over drop zone 420. (Preferably, the explanatory text “Text to be added:”, which is shown in view 430, is not included in the text that is dropped onto the drop zone.)

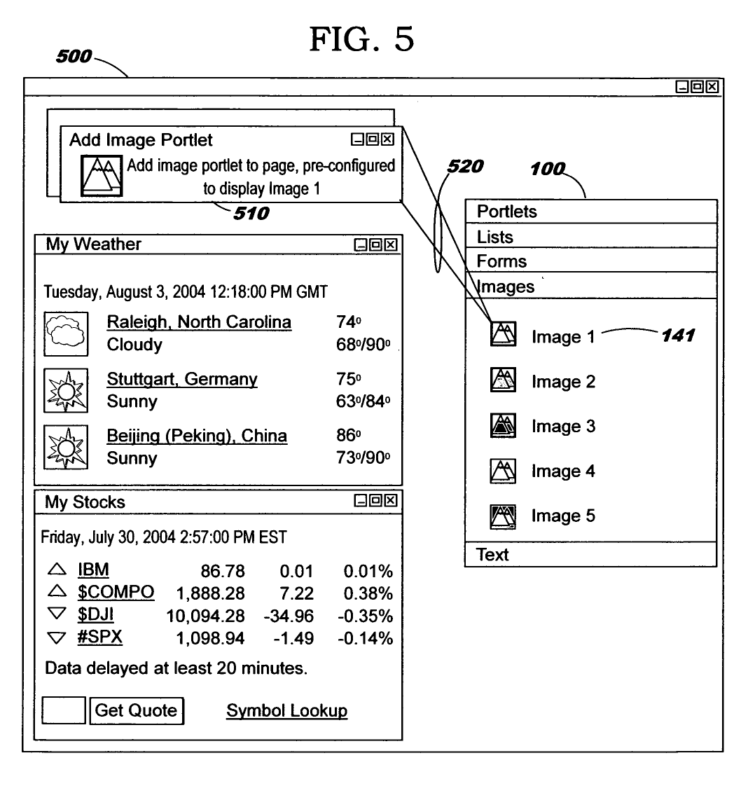

Similarly, a visual transform may specify that if an image content component is dragged over a portlet-type drop zone (signifying, for example, that the user desires to add an image viewer portlet to the page), then the image content component is to be visually transformed into a preview of an image portlet. This is illustrated in FIG. 5, where “Image 1” 141 is now dragged from palette 100 onto a drop zone of portal page 500, as shown generally by 520. In this example, a preview-type view 510 is rendered as the dragged image passes over the target drop zone. As noted by the text in view 510, the image portlet added in this manner may be pre-configured such that its initial or default display is an image of the source content component—i.e., an image of “Image 1” 141, in this case. (Preferably, the explanatory text “Add Image Portlet”, which is shown in view 510, is not included in the dropped image viewer portlet.)

For each match between a content component type and drop zone type, preferred embodiments also convert the configuration expression associated with the content component such that it matches the parameters consumed by the drop zone.

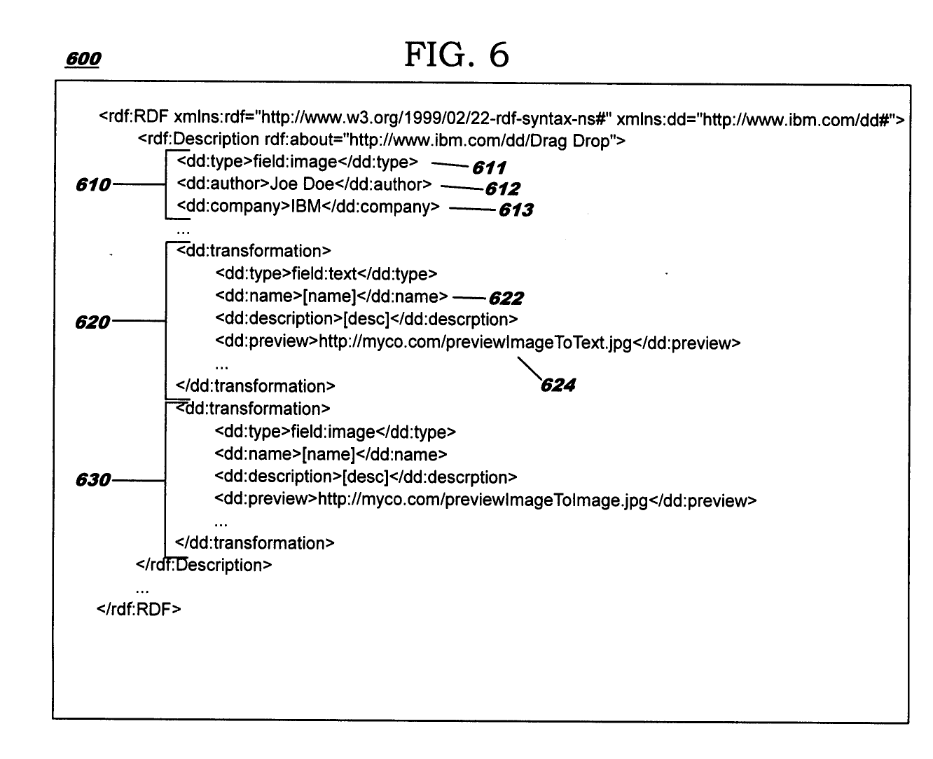

FIG. 6 illustrates a sample syntax that may be used for specifying information about visual transforms. As shown therein, a visual transform specification 600 provides various information 610 about the source content component, including its type 611. In this example, the source type information indicates that these visual transforms pertain to images (i.e., by the value “field:image” in the <type> element). Optional information such as an author 612 and company 613 may also be provided.

This sample 600 defines two transformations 620, 630. Transformation 620 is applicable to text-type drop zones, and transformation 630 is applicable to image-type drop zones, as indicated by the values of their respective “type” elements. In the sample syntax, a <name> element and <description> element are also provided for the transformations, along with a <preview> element. In this example, a uniform resource locator (“URL”) is specified as the value of the <preview> elements. Supposing that an image is dragged over a text-type drop zone, the URL at 624 may be invoked to generate a textual representation that will dropped in the drop zone when the drop operation completes.

Values for the elements in the transform syntax illustrated in FIG. 6 may be specified explicitly (as shown at 611). As an alternative, the transform syntax may use a reference to the markup language of the page (as shown at 622). Using the latter approach, the element's value is dynamically determined from the page markup.

In another aspect, the present invention provides a “component card” for a content component, where this component card is used to encapsulate the visualization of the content component and may also encapsulate other pertinent information. For example, a card can provide the name and description of the content component, the type of drop zones onto which the component can be dropped, a summary of the expressed configuration of the component, and also information such as the author and intended use of the component (for example, when dragging a portlet on a page). The information displayed on a particular card is preferably determined dynamically, rather than building and storing persistent component card objects.

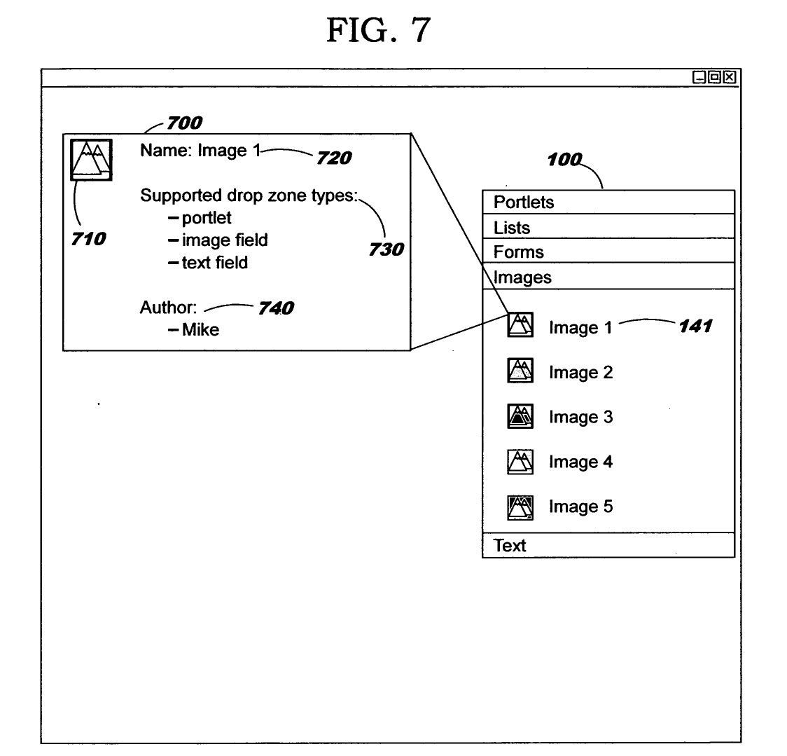

FIG. 7 illustrates a sample component card 700 for the “Image 1” component 141 As shown therein, a visualization 710 of the component is provided, along with a specification of the content component's name 720, supported drop zone types 730, and author 740. The component card for a particular content component may be displayed to a user for informative purposes, and this display may be triggered in various ways. For example, a component card may be displayed responsive to a right click operation while a mouse device or pointing cursor is positioned over the corresponding content component, or responsive to beginning a drag operation of the content component. (It should be noted that many alternative representations for component cards may be used, and thus the representation shown in FIG. 7 is provided by way of illustration but not of limitation.)

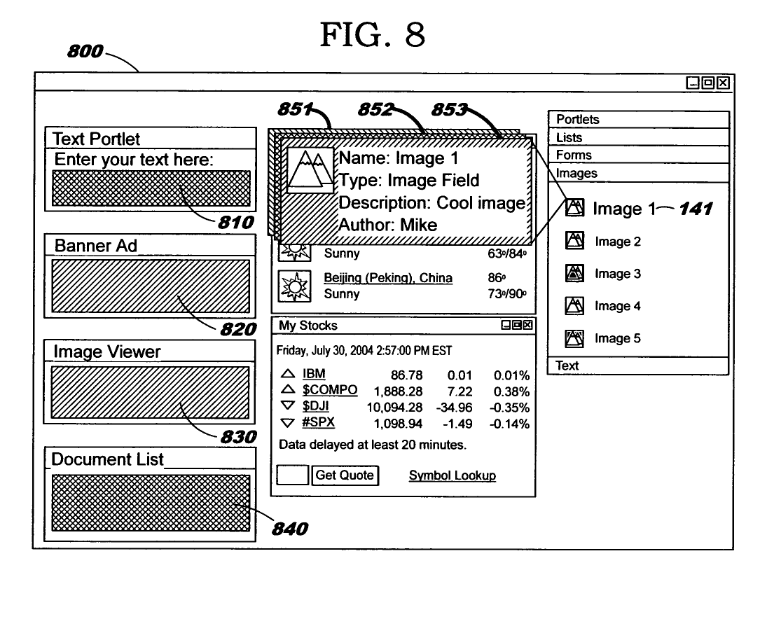

There may be many drop zones available on a particular page, and each matching pair of content component type and drop zone type may have multiple transformations. Thus, rather than using a component card of the type shown in FIG. 7 (which lists a plurality of drop zone types at 730), a “component card deck” may be used for each content component, where the deck has one component card for each transformation that is available for that content component. Preferably, a component card deck is rendered with a default or primary card brought to the front for display, and remaining cards cascaded to the back of the deck (and thus, the information on these non-primary cards may be at least partially obscured from the user's view; see, for example, non-primary cards 851, 852 in FIG. 8).

Since a component and drop zone pair can have more than one transform between them, preferred embodiments show the most applicable transform first in the deck. To determine what card to show first, as well as the order of component cards in the deck, preferred embodiments use proximity as input. In preferred embodiments, proximity is influenced by three factors: (1) the particular drop zone or zones near by; (2) the portlets or locations the component is dragged over; and (3) the portal or workplace page the component is being dragged on. (A suitable algorithm for combining these factors, given the teachings herein, may be developed by one of ordinary skill in the art. A detailed discussion of such algorithm is not deemed necessary to an understanding of the present invention.)

As drag zones come into proximity of a content component being dragged, the component card at the front of the deck may change dynamically. Furthermore, preferred embodiments enable a card in the deck to be selected at any time to bring it to the front. Selecting a card may be accomplished in a variety of ways, including enabling the user to click on the desired card, to tab between cards, to use the arrows keys to navigate between the cards, or to jump to the front or back of the deck using particular keys (such as the home and end keys, respectively).

The cards in the deck may be color-coded or otherwise visually distinguished, based on the transform type represented by that card, and the available drop zones on the page may be color-coded with a matching color. In this manner, the user can quickly discern the drop zones onto which a particular content component can be dropped. Thus, as the user drags a content component on a page, its available drop zones (based on type matching) may be visually highlighted. Furthermore, if the user selects a card to be brought to the front of the deck, the drop zones which are available for that transformation may be visually highlighted with the same color as the component card type color (and this highlighting may be irrespective of whether the corresponding content component is being moved about).

FIG. 8 illustrates use of a component card deck, where portal page 800 includes a component card deck having three component cards 851, 852, 853 corresponding to content component 141. Each of these component cards represents, in this example, a single transformation. The currently-displayed component card 853, for example, represents a transformation for an image drop zone type. Hashing is used in FIG. 8, rather than color, to visually highlight drop zones. (As yet another alternative, connectors—such as lines—or other types of visual indicators may be used to identify the drop zones which are available for a particular content component.) Thus, it can be seen by use of a first hashing pattern that drop zones 820, 830 are available for use with the transformation represented by component card 853 (that is, these drop zones accept an image). Drop zones 810, 840 use a second hashing pattern (i.e., a second visual highlighting) which matches that of component card 852. It may be presumed, since drop zone 810 is provided in a text portlet, that the transformation represented by component card 852 pertains to displaying text associated with content component 141 (such as the name, description, or perhaps the author of that content component).

As has been demonstrated, the present invention provides advantageous techniques that enable users to customize and personalize aggregated content in an intuitive, user-friendly manner, even though the user may not have experience with content manipulations in an aggregation framework.

Preferred embodiments have been described herein with reference to using a web portal/portlet model for content aggregation. It should be noted, however, that references herein to using portals, portlets, and workplaces are by way of illustration and not of limitation. Alternatively, techniques disclosed herein may be adapted for use with other content aggregation and content emitter models. The manner in which such adaptation may be carried out will be obvious to one of skill in the art, given the teachings provided herein.

As will be appreciated by one of skill in the art, embodiments of the present invention may be provided as methods, systems, or computer program products comprising computer-readable program code. Accordingly, the present invention may take the form of an entirely hardware embodiment, an entirely software embodiment, or an embodiment combining software and hardware aspects. The computer program products maybe embodied on one or more computer-usable storage media (including, but not limited to, disk storage, CD-ROM, optical storage, and so forth) having computer-readable program code embodied therein.

When implemented by computer-readable program code, the instructions contained therein may be provided to a processor of a general purpose computer, special purpose computer, embedded processor, or other programmable data processing apparatus to produce a machine, such that the instructions, which execute via the processor of the computer or other programmable data processing apparatus, create means for implementing embodiments of the present invention.

These computer-readable program code instructions may also be stored in a computer-readable memory that can direct a computer or other programmable data processing apparatus to function in a particular manner, such that the instructions stored in the computer-readable memory produce an article of manufacture including instruction means which implement embodiments of the present invention.

The computer-readable program code instructions may also be loaded onto a computer or other programmable data processing apparatus to cause a series of operational steps to be performed on the computer or other programmable apparatus to produce a computer-implemented method such that the instructions which execute on the computer or other programmable apparatus provide steps for implementing embodiments of the present invention.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

What is claimed is:

1. A computer-implemented method of identifying available content receiver locations on a content view generated by a content aggregation framework, comprising steps of:
determining, for a content component being moved about a rendered view generated by the content aggregation framework, a source type associated with the content component;
identifying one or more available content receiver locations on the rendered view, wherein a particular content receiver location is an available content receiver location if the particular content receiver location is capable of consuming the source type; and
visually highlighting at least one of the identified available content receiver locations, responsive to the identifying step.

2. The method according to claim 1, wherein the visually highlighting step further comprises one of altering a color of at least one of the identified available content receiver locations or providing a visual connector from the content component to at least one of the identified available content receiver locations.

3. The method according to claim 1, wherein the visually highlighting step further comprises providing a visual indication of a result of moving or copying the content component to at least one of the identified available content receiver locations.

4. The method according to claim 1, wherein the content component is provided on a content palette.

5. The method according to claim 1, wherein the content component is an already-rendered content component on the view.

6. A computer-implemented method of assisting users in modifying a content view generated by a content aggregation framework, comprising steps of:
identifying a content component to be moved or copied from a source location to a receiver location on a rendered view generated by the content aggregation framework;
first determining whether a type associated with the content component matches a type of the receiver location, and if so, visually indicating that the content component can be moved or copied to the receiver location; and
otherwise next determining whether a transform is available for the content component that transforms the type associated with the content component to a substitute type consumable by the receiver location, and if so, visually highlighting that the content component can be moved or copied to the receiver location.

7. The method according to claim 6, wherein the visually highlighting step further comprises visually indicating that a substitute form of the content component will result from moving or copying the content component to the receiver location.

8. The method according to claim 6, further comprising the step of automatically performing the transform that transforms the type associated with the content component to the consumable substitute type, responsive to moving or copying the content component to the receiver location following operation of the visually highlighting step.

9. The method according to claim 6, wherein the receiver location is dynamically identified as the content component moves within proximity thereof.

10. The method according to claim 9, wherein the dynamic identification triggers operation of the first determining step.

11. The method according to claim 6, wherein at least one of the visual indication and the visual highlighting comprises color coding of the receiver location.

12. The method according to claim 6, wherein at least one of the visual indication and the visual highlighting comprises rendering a preview of a result of moving or copying the content component to the receiver location.

13. The method according to claim 6, wherein the content component is selected from one of a content component palette or already-rendered content components of the rendered view.

14. The method according to claim 7, wherein the substitute form is defined in the transform.

15. The method according to claim 7, wherein the substitute form is dynamically determined using information specified in the transform.

16. A system for identifying available content receiver locations on a content view generated by a content aggregation framework, comprising:
a determination component for determining, for a content component being moved about a rendered view generated by the content aggregation framework, a source type associated with the content component;
an identification component for identifying one or more available content receiver locations on the rendered view, wherein a particular content receiver location is an available content receiver location if the particular content receiver location is capable of consuming the source type; and
a visual highlighting component for visually highlighting at least one of the identified available content receiver locations, responsive to the identifying by the identification component.

17. The system according to claim 16, wherein the visual highlighting component further provides a visual indication of a result of moving or copying the content component to at least one of the identified available content receiver locations.

18. A computer program product for assisting users in modifying a content view generated by a content aggregation framework, the computer program product embodied on one or more computer-readable media and comprising computer-readable instructions for:
identifying a content component to be moved or copied from a source location to a receiver location on a rendered view generated by the content aggregation framework;
determining whether a type associated with the content component matches a type of the receiver location, and if so, visually indicating that the content component can be moved or copied to the receiver location; and
otherwise determining whether a transform is available for the content component that transforms the type associated with the content component to a substitute type consumable by the receiver location, and if so, visually highlighting that the content component can be moved or copied to the receiver location.

19. The computer program product according to claim 18, wherein the computer-readable instructions for visually highlighting further comprise computer-readable instructions for visually indicating that a substitute form of the content component will result from moving or copying the content component to the receiver location.

20. The computer program product according to claim 18, further comprising computer-readable instructions for automatically performing the transform that transforms the type associated with the content component to the consumable substitute type, responsive to moving or copying the content component to the receiver location following the visual highlighting.
